(19) United States
(12) Patent Application Publication
(10) Pub. No.: US 2011/0063073 A1
(43) Pub. Date: Mar. 17, 2011

(54) TACTILE REMOTE CONTROL SYSTEM

(75) Inventors: MU-CHUN SU, TAOYUAN COUNTY (TW); CHIN-TENG LIN, HSINCHU COUNTY (TW); CHIN-YEN YEH, TAOYUAN COUNTY (TW); KUO-CHUN CHIU, TAOYUAN COUNTY (TW); YEN-TING LIN, HUALIEN COUNTY (TW); DE-YUAN HUANG, YUNLIN COUNTY (TW); YI-ZENG HSIEH, KAOHSIUNG CITY (TW); SHIH-CHIEH LIN, TAICHUNG CITY (TW); WEI-CHUN WANG, TAOYUAN COUNTY (TW); YOHANNES BUDIONO JINAWI, SURABAYA (ID); PO-CHIH CHEN, KAOHSIUNG CITY (TW)

(73) Assignee: NATIONAL CHIAO TUNG UNIVERSITY, HSINCHU CITY (TW)

(21) Appl. No.: 12/861,117

(22) Filed: Aug. 23, 2010

(30) Foreign Application Priority Data
Sep. 11, 2009 (TW) 098130774

(51) Int. Cl. G05B 19/02; G05B 11/01; G08C 19/16; G09B 21/00

(52) U.S. Cl. 340/4.11; 340/12.25; 340/4.12

(57) ABSTRACT

The present invention discloses a tactile remote control system, which uses a processor to integrate the operation selection items of controlled devices and arrange the selection items into a graphic user interface, and which uses a microswitch to output instructions. The processor arranges the graphic user interfaces of a controlled device hierarchically. Therefore, the graphic user interfaces have organizationality, logicality and continuity. The user watches the display and operates the microswitches to remotely control the controlled devices. The present invention integrates the control functions to assist the user to control the daily-life electronic devices and household appliances. The present invention enables any one, who has been briefly instructed, to remotely control the linked devices by his will.

### BACKGROUND OF THE INVENTION

1. Field of the Invention

The present invention relates to a remote control system, particularly to a tactile remote control system, wherein microswitches are used to input signals.

2. Description of the Related Art

With the advance of technology and science, more and more electric appliances are used in daily life. Conventionally, the start and operation of various appliances are separately controlled by different controllers, which is inconvenient and time-consuming. Therefore, it is favorable to integrate various controllers into a single device.

Some of the prior-art remote control systems are hand-free devices. For example, there is an eye-blink communication system, wherein a camera captures the images of the head, and an image processing technology obtains the characteristics of the user's eyes. The image variation between opening eyes and closing eyes is used to verify input signals. In cooperation with the related software, the abovementioned technology can control various devices remotely. Although the eye-blink communication system can be operated simply, it has disadvantages of low operating speed and ocular fatigue. Another prior art proposes an EOG (electro-oculograph) technology, which is based on the voltage difference between the cornea and retina of the eyeball. A plurality of electrodes is attached to the perimeter of the eye. The technology detects the direction of eye movement and the blinks of the eye according to the voltage variation between electrodes. The direction of eye movement is used to control the movement of the operating cursor, and the eye blinks are used as the input signal. However, the aging and regeneration of the horny layer of the skin would vary the resistance and voltage detected by the electrodes attached to the skin. Therefore, the OEG device is unsuitable for long-term wear.

Another prior art proposes an infra-red video system (IRVS), which projects infrared ray onto the eye and its perimeter and uses an infrared camera to detect the pupil to track the movement of the pupil. A system software controls the cursor according to the movement of the pupil. However, the user will be tired by that he has to persistently face the camera. Besides, IRVS is very expensive. Thus, a manufacturer proposes a low-cost and easy-to-operate IROG (infrared oculography) technology, wherein an infrared source and an infrared receiver are arranged on an eyeglass frame. Infrared ray is also projected onto the eye and its perimeter. The infrared receiver receives the reflections from the pupil, iris and sclera and converts the reflections into a current signal. The system differentially amplifies the current signal, determines the turning angle of the eyeball according to value of the signal, and translates the turning angle into an instruction. However, short-range use of infrared ray is likely to irritate the eyes, and long-term use of infrared ray may harm the eyes. Recently, a research organization proposed an optical-type eye tracking system, which comprises a head-mounted display, a light source on the display, and a camera below the display. The user wears the head-mounted display, and the camera detects the position of the pupil. The image processing sets the center of the pupil as the operating cursor. Thereby, the user can use his eye to control the operating cursor. However, the head-mounted display is heavy and burdensome for the user. Further, the head-mounted display is likely to slip down, causing a wrong signal.

From the above description, it is known that the conventional designs have systematic drawbacks and operating inconveniences. Thus, the present invention proposes a novel tactile remote control system to overcome the conventional problems.

### SUMMARY OF THE INVENTION

The primary objective of the present invention is to provide a tactile remote control system, whose interface is simple and easy-to-operate, and whose price is not too high.

Another objective of the present invention is to provide a tactile remote control system, whose determination process is simple and free of complicated recognition procedures, wherefore the probability of wrong judgement is reduced.

To achieve the abovementioned objectives, the present invention uses a processor to control at least one controlled device. The processor is connected with a display and a microswitch. The processor presents a graphic user interface of the controlled device on the display. The graphic user interface has a plurality of function keys. The function keys respectively control corresponding actions of the controlled device. The microswitch sends a remote control signal to the processor according to the graphic user interface. The processor remotely controls the controlled device according to the remote control signal.

When controlling a plurality of controlled devices, the processor will establish a graphic user interface for each controlled device, and alternately and cyclically presents all the graphic user interfaces on the display. The microswitch sends a remote control signal to the processor according to the contents presented on the display, and the processor presents a special graphic user interface. Then, the microswitch further operates a function key on the graphic user interface.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a block diagram schematically showing the architecture of a tactile remote control system according to a first embodiment of the present invention;

FIG. 2 is a diagram schematically showing the application of the tactile remote control system according to the first embodiment of the present invention;

FIG. 3 is a block diagram schematically showing the operating interface the processor establishes for the controlled devices according to the first embodiment of the present invention;

FIG. 4(a) is a diagram schematically showing the structure of a microswitch according to the first embodiment of the present invention;

FIG. 4(b) is another diagram schematically showing the structure of a microswitch according to the first embodiment of the present invention;

FIG. 5 is a diagram schematically showing that a display alternately and cyclically presents control keys according to the first embodiment of the present invention;

FIGS. 6(a) and 6(b) are diagrams schematically a three-stage operating interface according to the first embodiment of the present invention;

FIG. 7 is a block diagram schematically showing the architecture of a tactile remote control system according to a second embodiment of the present invention; and

FIG. 8 is a diagram schematically showing the application of the tactile remote control system according to the second embodiment of the present invention.

### DETAILED DESCRIPTION OF THE INVENTION

The primary objective of the present invention is to provide a tactile remote control system, which integrates the control functions of the daily-life electric appliances to satisfy some special users, and which is operated in a tactile way, and which provides an easy-to-understand graphic user interface, whereby any person can operate the tactile remote control system after a brief instruction.

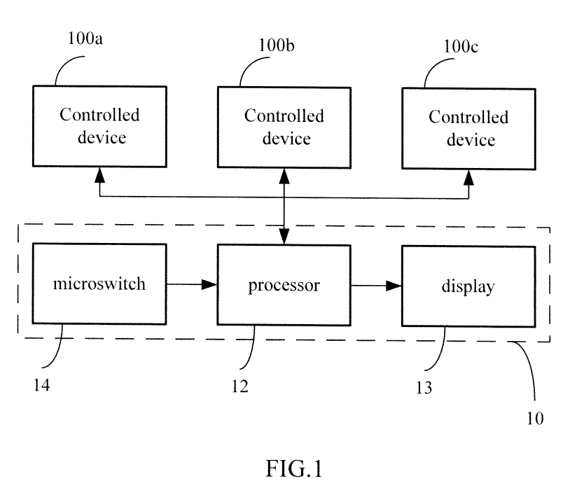

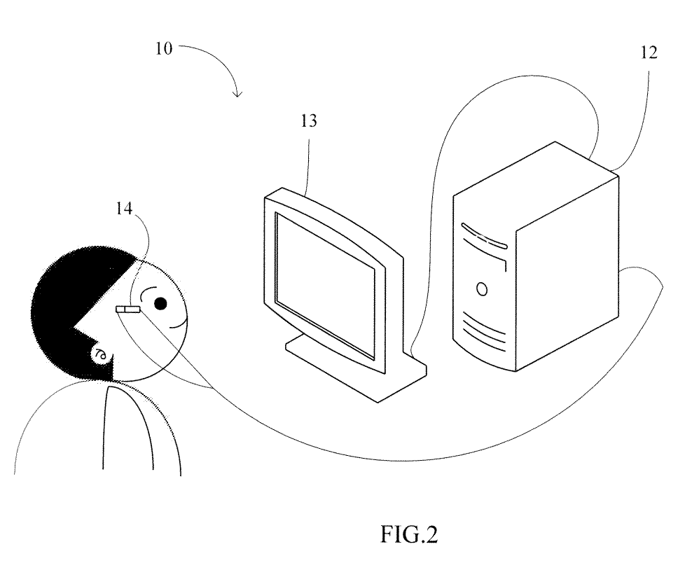

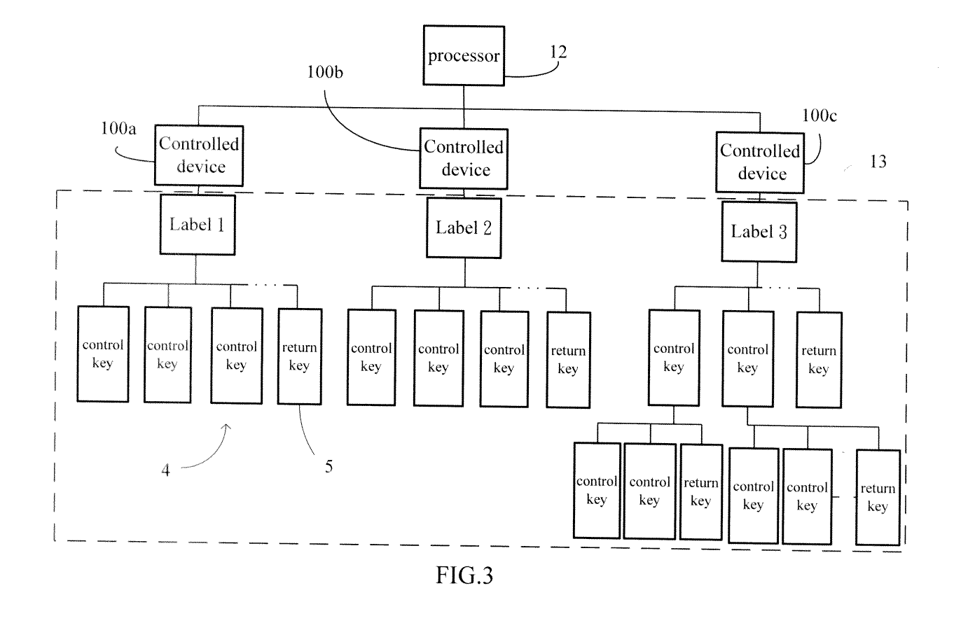

Refer to FIG. 1 and FIG. 2. FIG. 1 is a block diagram schematically showing the architecture of a tactile remote control system according to a first embodiment of the present invention. FIG. 2 is a diagram schematically showing the application of the tactile remote control system according to the first embodiment of the present invention. The tactile remote control system 10 of the present invention comprises a processor 12, a display 13 connected with the processor 12, and a microswitch 14. In one embodiment, the processor 12 is a central processing unit (CPU) of a computer. The CPU is connected with a plurality of controlled devices 100a, 100b and 100c. The controlled devices 100a, 100b and 100c may be audio/video softwares of a computer, Internet-access elements of a computer, or daily-life electric appliances, such as electric fans, air conditioners, and televisions. In fact, the controlled device may be any electric device the user demands. Refer to FIG. 3. According to the operation requirements, the processor 12 respectively establish a label 1, a label 2, and a label 3 for the controlled devices 100a, 100b and 100c, and also establishes a plurality of control keys 4 and a return key 5 for each label hierarchically. The control keys 4 are organized logically according to the operation procedures and the relationship therebetween. The processor 12 organizes the labels 1, 2, and 3 of the same layer, or the control keys 4 and the return key 5 of the same layer, into a graphic user interface (GUI). The processor 12 presents the GUI on the display 13, wherein the processor 12 alternately and cyclically presents the labels 1, 2, and 3, or the control keys 4 and the return key 5 on the display 13.

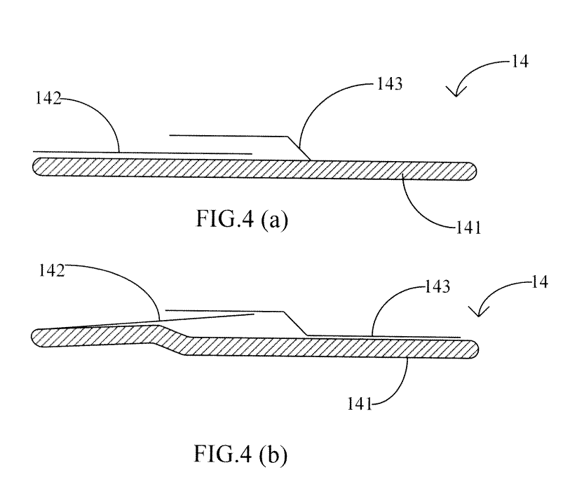

Refer to FIG. 4(a). The microswitch 14 comprises a non-woven fabric 141, a negative electrode plate 142 arranged on the non-woven fabric 141, and a positive electrode plate 143 installed at the top of the non-woven fabric 141 and extending to above the negative electrode plate 142. The microswitch 14 may be attached to any region of the body. For example, the microswitch 14 is attached to the eyebrow in this embodiment. To prevent the microswitch 14 from slipping off, the non-woven fabric 141 may be a self-adhesive non-woven fabric able to stick to the body. In the present invention, another flexible material may replace the non-woven fabric 141. Refer to FIG. 4(b). A gap originally exists between the negative electrode 142 and the positive electrode plate 143. When the user raises his head, the non-woven fabric 141 deforms, which makes the negative and positive electrode plates 142 and 143 contact each other and causes electric conduction between the negative and positive electrode plates 142 and 143. The processor 12 receives the signal of electric conduction and executes the function of a label or a function key on the display 13. The user watches the presentation of the display 13 and uses the microswitch to select the intended function. The user can repeat the abovementioned procedures to remotely control the operations of the controlled device step-by-step.

The present invention does not limit the position where the microswitch is attached. The microswitch may also be attached to fingers or other positions where the muscle works. To reduce the probability of wrong triggering, each GUI has a return key. Alternatively, the triggering is delayed for a predetermined period of time. Once no remote control signal is received within the predetermined period of time, GUI returns to the preceding layer. Alternatively, the processor 12 confirms an instruction with quick double clicks of the microswitch. In the present invention, the operating modes can be modified according to practical conditions.

Below, several embodiments are used to further exemplify the present invention.

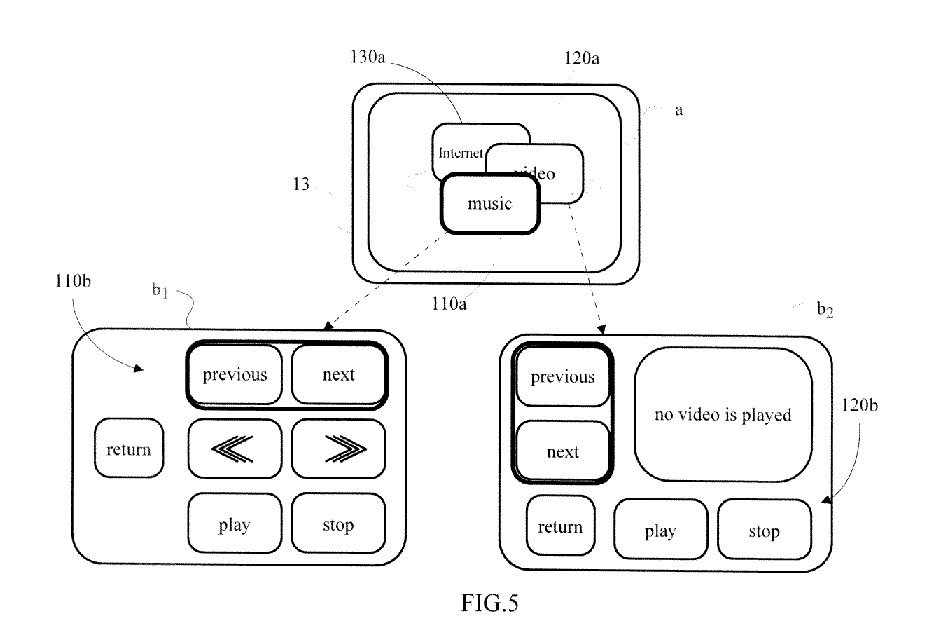

Refer to FIG. 5. In this embodiment, the tactile remote control system is used to control the music play software, video play software and Internet-access element in a computer. Firstly, the processor 12 respectively establishes a music label 110a, a video label 120a, and an Internet-access label 130a respectively for the music play software, video play software and Internet-access element. The labels 110a, 120a and 130a are respectively linked to corresponding control keys 110b, 120b, and 130b (the control keys 130b are not shown in FIG. 5). The processor 12 arranges the labels 110a, 120a, and 130a in the same GUI a and presents them on the display 13 alternately and cyclically according to the sequence of execution.

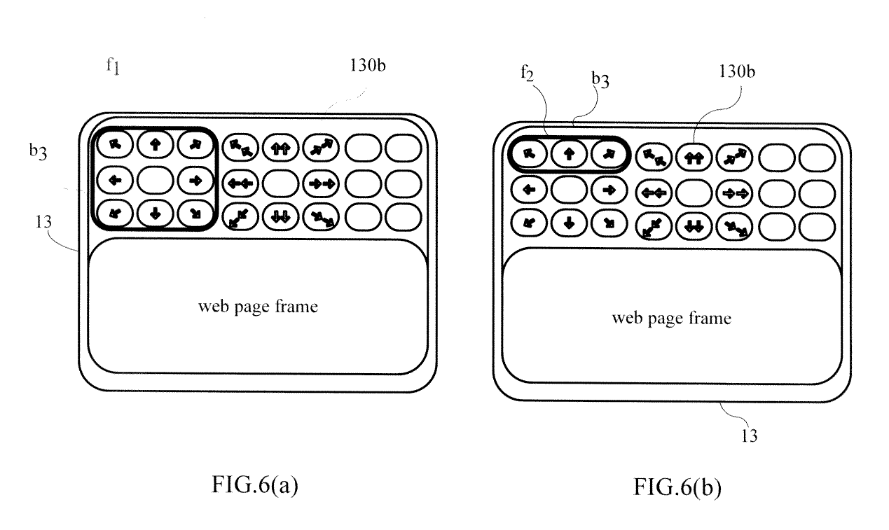

The music label 110a is linked to a control GUI b1, which contains all the control keys 110b. Similarly, the video label 120a is linked to a control GUI b2, which contains all the control keys 120b. In order to short the time that the control keys 110b or 120b are alternately and cyclically presented on the display 13, the processor 12 presents the control keys 110b of the control GUI b1 and the control keys 120b of the control GUI b2 in a two-item selection way. Two related selection items are arranged into a selection group and encircled by a boldface frame. The selection groups are alternately and cyclically presented in a sequence from a larger field to a smaller field. The user can promptly select one of the selection groups and then select one of the selection items from the selection group. Refer to FIG. 6(a) and FIG. 6(b). The Internet-access label 130a is linked to a control GUI b3, which contains all the control keys 130b for Internet access. As the operation of Internet access is more complicated, it needs more selection items. Therefore, the control GUI b3 contains more control keys 130b. The processor 12 arranges the control keys 130b into an m (rows)×n (columns) array. The processor 12 presents the control GUI b3 containing m×n control keys 130b on the display 13 in a sequence from large selection groups to small selection groups. For example, an i (rows)×j (columns) array of control keys 130b is arranged into a large selection group. In this embodiment, a 3×3 array is arranged into a large selection group f1. Then, a row or a column of the large selection group f1 is assigned to be a small selection group f2. For example, the row (i=l, j=n) or the column (i=m, j=l) of the 3×3 array is assigned to be a small selection group f2. In this embodiment, each small selection group f2 has 1×3 pieces of control keys 130b encircled by a boldface frame. Thus, the user determines a selection field from the large selection groups f1 firstly, and then selects a small selection group f2 from the determined large selection group f1 to reduce the selection field, and finally selects a desired control key 130b from the selected small selection group f1. The processor 12 receives the remote control signal of selecting the desired control key 130b and executes the instruction of the remote control signal. Such a mode of from a large selection field to a small selection field can accelerate the operation speed. If there are a greater number of labels at the beginning of the selection operation, the labels can also be arranged in the same way to accelerate the operation speed.

The abovementioned hierarchical selection mode has advantages of fast operation and precise selection. The number of selection groups can vary according to the number of the selection items of the controlled device. In the present invention, the control GUI can be customized according to the requirements of the controlled device. The present invention is not limited by the embodiments described above. Any modification or variation according to the spirit disclosed in the specification is to be also included within the scope of the present invention.

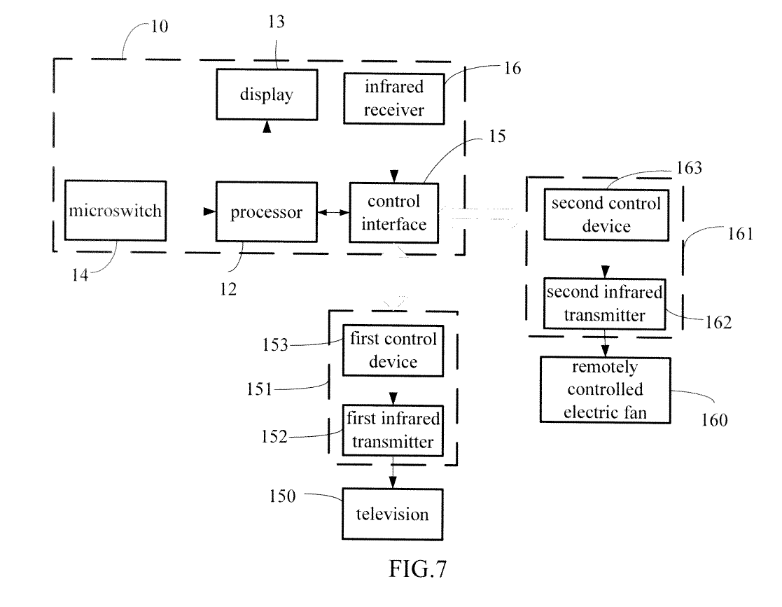

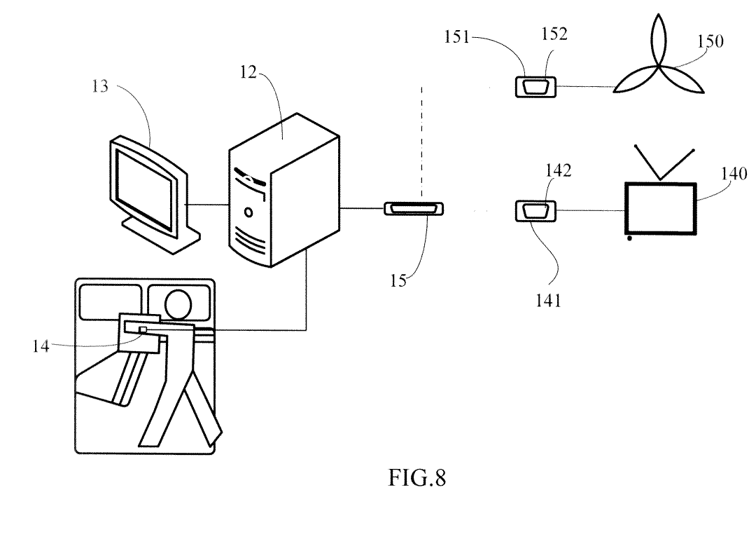

The tactile remote control system of the present invention can apply to various devices. In addition to the abovementioned softwares of a computer, the present invention can also control household appliances, such as air conditioners, electric lights, televisions, etc., via infrared or Bluetooth communication. Refer to FIG. 7 and FIG. 8. FIG. 7 is a block diagram of the architecture of a tactile remote control system according to a second embodiment of the present invention. FIG. 8 is a diagram schematically showing the application of the tactile remote control system according to the second embodiment of the present invention. In the second embodiment, the tactile remote control system remotely controls a television 150 and a remotely controlled electric fan 160 via infrared transmission. The television 150 has a first remote controller 151, which contains a first infrared transmitter 152 and a first control device 153. The remotely controlled electric fan 160 has a second remote controller 161, which contains a second infrared transmitter 162 and a second control device 163. In the second embodiment, the processor 12 links to a control interface 15, and the control interface 15 further links to an infrared receiver 16. The control interface 15, first control device 153 and second control device 163 may be realized with micro controller units (MCU).

In the second embodiment, the system acquires the control codes of the first and second infrared transmitters 152 and 162 via the infrared receiver 16, and the control interface 15 stores the control codes in the processor 12. The user clicks the control keys of the control GUI to enable the control interface 15 to remotely control the first control device 153, and the first control device 153 drives the first infrared transmitter 152 to control the operations of the television 150. Alternately, the processor 12 remotely controls the second control device 163 via the control interface 15 to enable the second infrared transmitter 162 to control the operations of the electric fan 160. In the second embodiment, the processor 12 presents similar control GUI's, and the control process is also similar to that of the first embodiment. Therefore, they are not repeated again herein.

In conclusion, the present invention has the following characteristics. Firstly, the present invention is inexpensive because of a simple structure. Secondly, the cyclic operation mode is easy to understand and able to precisely select the desired item. Thirdly, the operation from large selection groups to small selection groups enables the user to lock the desired operation of the controlled device. Fourthly, the present invention is a diversified remote control system, which can remotely control not only computer softwares but also household appliances. Besides, the control GUI of the present invention can be flexibly modified to control various devices.

The embodiments described above are to demonstrate the technical contents and characteristics of the present invention to enable the persons skilled in the art to understand, make, and use the present invention. However, these embodiments are not intended to limit the scope of the present invention. Any equivalent modification or variation according to the spirit of the present invention is to be also included within scope of the present invention.

What is claimed is:

1. A tactile remote control system, which is used to control at least one controlled device, comprising
a processor controlling said controlled device and having at least one graphic user interface, wherein said graphic user interface has a plurality of function keys, and wherein each said function key is used to remotely control an operation of said controlled device;
a display electrically connected with said processor and presenting said graphic user interface and said function keys; and
at least one microswitch connected with said processor and used to click one said function key to send out a remote control signal to instruct said processor to remotely control said controlled device to operate.

2. The tactile remote control system according to claim 1, wherein said processor links to a plurality of said controlled devices, and wherein said processor establishes a label for each said controlled device and establishes at least one said graphic user interface for each said label, wherein said processor alternately and cyclically presents said labels on said display, and wherein said microswitch is used to click one said label presented on said display to enter one said graphic user interface that links to said label.

3. The tactile remote control system according to claim 2, wherein a given interval of time is preset in said processor, and wherein if said processor does not receive said remote control signal within said given interval of time, said processor resumes alternately and cyclically presenting said labels.

4. The tactile remote control system according to claim 2, wherein said function keys include at least one return key, and wherein when said return key is clicked, said processor resumes alternately and cyclically presenting said labels.

5. The tactile remote control system according to claim 2, wherein said labels or said function keys are presented on said display in form of an m(rows)×n(columns) array, and wherein m×n pieces of said labels or said function keys are divided into a plurality of units, and wherein said display alternately and cyclically presents said units, and wherein said microswitch uses said remote control signal to select one of said units that are being presented on said display, and wherein each said unit includes i (rows)×j (columns) pieces of said labels or said function keys, and wherein all said labels or all said control keys of said unit that has been selected are alternately and cyclically presented, and wherein said microswitch uses said remote control signal to select said label or said control key that is being presented on said display to enter said graphic user interface linking to said label or said control key.

6. The tactile remote control system according to claim 5, wherein said processor sets that i=l and j=n for said units, and wherein said processor alternately and cyclically presents said units row by row.

7. The tactile remote control system according to claim 5, wherein said processor sets that i=m and j=l for said units, and wherein said processor alternately and cyclically presents said units column by column.

8. The tactile remote control system according to claim 1, wherein said processor is a central processing unit of a computer.

9. The tactile remote control system according to claim 1, wherein said controlled device is an audio/video play media or an Internet-access element of a computer.

10. The tactile remote control system according to claim 1, wherein said controlled device is an electric light, a television, an audio device, or an electric fan.

11. The tactile remote control system according to claim 10, wherein each said controlled device has a remote controller, and wherein said remote controller includes an infrared transmitter and a control device, and wherein said tactile remote control system further comprises a control interface and an infrared receiver sequentially linking to said processor, and wherein said control interface and said control device have an identical program code reading frame, and wherein said infrared receiver receives a control code from said infrared transmitter, and wherein said processor receives said control code via said control interface and records said control code, and wherein when said microswitch sends out said remote control signal, said processor uses said control code to instruct said control interface to remotely control said control device, and wherein said control device instructs said infrared transmitter to enable said controlled device to operate.

12. The tactile remote control system according to claim 1, wherein said processor alternately and cyclically presents said function keys of each said graphic user interface on said display.

13. The tactile remote control system according to claim 1, wherein said processor is programmed not to send out said remote control signal unless said microswitch is clicked twice continuously.
